(19) United States
(12) Patent Application Publication
(10) Pub. No.: US 2022/0299992 A1
(43) Pub. Date: Sep. 22, 2022

(54) METHOD FOR THE AT LEAST ASSISTED CROSSING OF A JUNCTION BY A MOTOR VEHICLE

(71) Applicant: Robert Bosch GmbH, Stuttgart (DE)

(72) Inventors: Stefan Nordbruch, Leonberg (DE); Carolin Noack, Bad Segeberg (DE); Di Zhang, Stuttgart (DE); Kurt Eckert, Ditzingen (DE); Michael Kram, Renningen (DE); Rolf Nicodemus, Bietigheim-Bissingen (DE); Ruediger-Walter Henn, Weil Der Stadt (DE); Ulrich Schulmeister, Bietigheim-Bissingen (DE); Wolfgang Niem, Hildesheim (DE)

(21) Appl. No.: 17/641,577

(22) PCT Filed: Jul. 27, 2020
(86) PCT No.: PCT/EP2020/071091

§ 371 Date: Mar. 9, 2022

(30) Foreign Application Priority Data
Sep. 23, 2019 (DE) 10 2019 214 420.9

(51) Int. Cl. G05D 1/00; B60W 30/18; B60W 50/029; B60W 50/02; H04W 4/44; H04L 9/00

(52) U.S. Cl. CPC G05D 1/0022; G05D 1/0061; G05D 1/0077; B60W 30/18159; B60W 50/029; B60W 50/0205; H04W 4/44; H04L 9/50; G05D 2201/0213; B60W 2050/0292; B60W 2050/021; B60W 2556/50; H04L 2209/80; H04L 2209/84

(57) ABSTRACT

A method for the at least assisted crossing of a junction by a motor vehicle. The method includes: receiving signals from the surroundings, which represent surroundings of the motor vehicle that at least partially include a junction, generating remote control signals for remotely controlling a lateral guidance and/or longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner, outputting the generated remote control signals. A device, a computer program, and a machine-readable memory medium, are also described.

### FIELD

The present invention relates to a method for the at least assisted crossing of a junction by a motor vehicle. The present invention further relates to a device, to a computer program and to a machine-readable memory medium.

### BACKGROUND INFORMATION

German Patent Application No. DE 10 2018 129 066 A1 describes systems and methods for unprotected left turning in heavy traffic situations in autonomous vehicles.

German Patent Application No. DE 11 2016 002 832 T5 of the international application with the PCT Patent Application No. WO 2016/209415 describes safety systems and methods for autonomous vehicles.

German Patent Application No. DE 11 2016 007 093 T5 of the international application with the PCT Patent Application No. WO 2018/038700 describes a vehicle access authorization.

### SUMMARY

An object of the present invention is to provide for the efficient at least assisted crossing of a junction by a motor vehicle.

This object may achieved with the aid of the present invention. Advantageous embodiments of the present invention are disclosed herein.

According to one first aspect of the present invention, a method is provided for the at least assisted crossing of a junction by a motor vehicle. In an example embodiment of the present invention, the method include the following steps:

receiving signals from the surroundings, which represent surroundings of the motor vehicle that at least partially include a junction,

generating remote control signals for remotely controlling a lateral guidance and/or longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner,

outputting the generated remote control signals.

According to one second aspect of the present invention, a device is provided, which is configured to carry out all steps of the method according to the first aspect.

According to one third aspect of the present invention, a computer program is provided, which includes commands which, upon execution of the computer program by a computer, for example, by a device according to the second aspect, prompt the computer to carry out a method according to the first aspect.

According to one fourth aspect of the present invention, a machine-readable memory medium is provided, on which the computer program according to the third aspect is stored.

The present invention is based on and includes the finding that the above object may be achieved by assisting the motor vehicle when crossing a junction in such a way that the lateral guidance and/or the longitudinal guidance of the motor vehicle is/are remotely controlled. This yields, for example, the technical advantage that the motor vehicle may be efficiently assisted when crossing a junction.

This may yield, in particular, the technical advantage that a concept is provided for the efficient, at least assisted crossing of a junction by a motor vehicle.

According to one specific embodiment of the present invention, a step of determining provided that a motor vehicle is to cross a junction is provided.

An assisted crossing includes, in particular, the case in which only the lateral guidance or only the longitudinal guidance of the motor vehicle is remotely controlled. The wording “assisted crossing” includes, in particular, the case in which both the lateral guidance as well as the longitudinal guidance of the motor vehicle are remotely controlled.

In the case in which remote control signals are provided for controlling the lateral guidance and longitudinal guidance of the motor vehicle, it is provided according to one specific embodiment of the present invention that the corresponding other guidance, i.e., the longitudinal guidance or the lateral guidance, is either manually controlled by the driver or is at least semi-automatically controlled, in order to drive the motor vehicle in an at least semi-automated manner, so that the motor vehicle crosses or is able to cross the junction in an at least assisted manner.

The wording “drive in at least a semi-automated manner” includes one or multiple of the following cases: semi-automated driving, highly automated driving, fully automated driving.

Semi-automated driving means that in a specific situation (for example: driving on an expressway, driving within a parking facility, passing an object, driving within a lane defined by lane markings) and/or for a certain period of time, a longitudinal guidance and a lateral guidance of the motor vehicle are automatically remotely controlled. A driver of the motor vehicle does not have to manually control the longitudinal guidance and the lateral guidance of the motor vehicle himself/herself. The driver must, however, continuously monitor the automatic remote control of the longitudinal guidance and the lateral guidance, in order to be able to manually intervene if necessary. The driver must be ready to take complete control of the vehicle guidance at any time.

Highly automated driving means that for a certain period of time in a specific situation (for example: driving on an expressway, driving within a parking facility, passing an object, driving within a lane defined by lane markings), a longitudinal guidance and a lateral guidance of the motor vehicle are automatically remotely controlled. A driver of the motor vehicle does not have to manually control the longitudinal guidance and the lateral guidance of the motor vehicle himself/herself. The driver does not have to continuously monitor the automatic remote control of the longitudinal guidance and the lateral guidance in order to be able to manually intervene if necessary. A take control request is automatically output to the driver if necessary for taking control of the longitudinal guidance and lateral guidance, in particular, output with a sufficient time reserve. Thus, the driver must potentially be able to take control of the longitudinal guidance and the lateral guidance. Limits to the automatic remote control of the lateral guidance and the longitudinal guidance are recognized automatically. During highly automated driving, it is not possible to automatically initiate a minimal risk state in every initial situation.

Fully automated driving means that in a specific situation (for example: driving on an expressway, driving within a parking facility, passing an object, driving within a lane defined by lane markings), a longitudinal guidance and a lateral guidance of the motor vehicle are automatically remotely controlled. A driver of the vehicle does not have to manually control the longitudinal guidance and lateral guidance of the motor vehicle himself/herself. The driver does not have to continually monitor the automatic remote control of the longitudinal guidance and the lateral guidance in order to be able to manually intervene if necessary. Prior to a termination of the automatic remote control of the lateral guidance and the longitudinal guidance, a request is automatically made to the driver to take over the driving task (controlling the lateral guidance and the longitudinal guidance of the motor vehicle), in particular, with a sufficient time reserve. If the driver does not take over the driving task, a return is automatically made to a minimal risk state. Limits of the automatic control of the lateral guidance and the longitudinal guidance are automatically recognized. In all situations, it is possible to return to a minimal risk system state.

According to one specific embodiment of the present invention, it is provided that safety condition signals are received, which represent at least one safety condition that must be met so that the motor vehicle may be remotely controlled, it being checked whether the at least one safety condition is met, the remote control signals being generated based on a result of the check whether the at least one safety condition is met.

This may yield, for example, the technical advantage that the remote control signals may be efficiently generated. This yields, in particular, the technical advantage that it may be efficiently assured that particular requirements, in the present case, the safety condition, are met for remotely controlling the motor vehicle. Thus, this yields, in particular, the technical advantage that if the safety condition is met, the remote control of the motor vehicle is safely possible.

According to one specific embodiment of the present invention, it is provided that the at least one safety condition is in each case an element selected from the following groups of safety conditions: presence of a predetermined safety integrity level (SIL) or automotive safety integrity level (ASIL) of at least the motor vehicle and of an infrastructure, in particular, including a communication path and/or communication component (for example, communication interface), for remotely controlling a motor vehicle, in particular, with respect to the entire systems in the motor vehicle and in the infrastructure and, in particular, parts; for example, components, algorithms, interfaces, etc., presence of a maximum latency period of a communication between the motor vehicle and a remote control unit for remotely controlling the motor vehicle based on the remote control signals, presence of a predetermined computer protection level of a device for carrying out the steps of the method according to the first aspect, presence of predetermined components and/or algorithms and/or communication options, which are used for carrying out the steps of the method according to the first aspect, presence of a redundancy and/or of a diversity in predetermined components and/or in algorithms and/or in communication options, which are used for carrying out the steps of the method according to the first aspect, presence of predetermined availability indications, which indicate an availability of predetermined components and/or of algorithms and/or of communication options, presence of predetermined quality criteria of the predetermined components and/or of algorithms and/or of communication options, presence of a plan that includes measures for reducing errors and/or measures in the case of failures of predetermined components and/or of algorithms and/or of communication options and/or measures for error analyses and/or measures in the case of misinterpretations, presence of one or of multiple fall-back scenarios, presence of a predetermined function, presence of a predetermined traffic situation, presence of predetermined weather, maximum possible time for respectively carrying out and/or executing one step or multiple steps of the method according to the first aspect, presence of a check result that elements and/or functions that are used for carrying out the method according to the first aspect presently function correctly.

A communication path is, for example, a communication path between the device according to the second aspect and the motor vehicle. A communication path includes, for example, one or multiple communication channels.

In one specific embodiment of the present invention, a component that is used for carrying out the method according to the first aspect is an element selected from the following group of components: surroundings sensor, motor vehicle, infrastructure, remote control unit, device according to the second aspect, motor vehicle system, in particular, drive system, clutch system, braking system, driver assistance system, communication interface of the motor vehicle and/or of the infrastructure, processor, input, output of the device according to the second aspect.

In one specific embodiment of the present invention, a function that is used for carrying out the method according to the first aspect is an element selected from the following group of functions: remote control function, communication function between the motor vehicle and the infrastructure and/or of the remote control unit, evaluation function of surroundings sensor data of a surroundings sensor, planning function, in particular, driving planning function, traffic analysis function.

A computer protection level defines, in particular, the following: activated firewall and/or valid encryption certificate for encrypting a communication between the motor vehicle and the infrastructure or the remote control unit and/or activated virus program including updated virus signatures and/or presence of a protection, in particular, of a mechanical protection, in particular, of an intrusion protection, of the computer, in particular, of the device according to the second aspect and/or of the remote control unit and/or presence of a possibility of checking that signals, in particular, remote control signals or signals from the surroundings have been transferred correctly, i.e., in an error-free manner.

An algorithm includes, for example, the computer program according to the third aspect.

Checking, in particular, that a redundancy and/or a diversity in predetermined components and/or in algorithms and/or in communication options is/are present yields, for example, the technical advantage that upon failure of the corresponding component, for example, of a computer or of the corresponding algorithm or of the corresponding communication option, a secure function may still be carried out.

To ensure that results are correct, the results may according to one specific embodiment be calculated multiple times, for example, corresponding results may be compared with one another. Only upon agreement of the result is it determined, for example, that the results are correct. If a number is odd multiple times, it may be provided, for example, that the result corresponding to the highest number of identical results is determined to be correct.

Remote control signals are generated, for example, only when it may be determined that the result is correct.

In one specific embodiment of the present invention, it is provided that the remote control signals are generated only when the at least one safety condition is met.

In one specific embodiment of the present invention, it is provided that the check whether the at least one safety condition is met is carried out before and/or after and/or during one or multiple predetermined method steps.

This may yield, in particular, the technical advantage that it may be efficiently ensured that particular requirements, in the present case, the safety condition, for a remote control of the motor vehicle are met before and/or after and/or during the implementation of the corresponding method steps. Thus, this yields, in particular, the technical advantage that when the safety condition is met, the remote control of the motor vehicle is then safely possible.

In one specific embodiment of the present invention, it is provided that after outputting the remote control signals, a remote control of the lateral guidance and/or longitudinal guidance of the motor vehicle based on the output remote control signals is checked in order to detect an error, upon detection of an error, the remote control being aborted or emergency remote control signals being generated and output in a case of emergency for remotely controlling the lateral guidance and/or the longitudinal guidance of the motor vehicle.

The emergency remote control signals are, for example, of the type that during a remote control of the lateral guidance and/or the longitudinal guidance of the motor vehicle based on the emergency remote control signals, the motor vehicle is transferred to a safe state, in particular, is stopped.

In one specific embodiment of the present invention, it is provided that after outputting the remote control signals, a remote control of the lateral guidance and/or longitudinal guidance of the motor vehicle is checked based on the output remote control signals in order to detect an error, upon detection of an error, the remote control being aborted or on-board emergency control signals being generated and output in a case of emergency for controlling the lateral guidance and/or the longitudinal guidance of the motor vehicle.

The on-board emergency control signals are, for example, of the type that when controlling the lateral guidance and/or the longitudinal guidance of the motor vehicle based on the on-board emergency control signals, the motor vehicle is transferred to a safe state, in particular, is stopped.

On-board emergency control signals are thus emergency control signals, which the motor vehicle itself generates or are generated in the motor vehicle.

This may yield, for example, the technical advantage that even upon a failure of a communication, which corresponds to a case of emergency, for example, between the motor vehicle and the device according to the second aspect or a remote control unit for remotely controlling the motor vehicle, the motor vehicle is able itself to transition into a safe state.

Embodiments, which are made in conjunction with the remote control signals or the on-board emergency control signals, apply similarly to the emergency remote control signals and vice versa.

According to one specific embodiment of the present invention, it is provided that identification signals are received, which represent a respective identification of at least one of the motor vehicle, of an owner of the motor vehicle, and of a driver of the motor vehicle (i.e., a respective identification of the motor vehicle and/or of an owner of the motor vehicle and/or of a driver), the remote control signals being generated based on the respective identification.

This may yield, for example, the technical advantage that the remote control signals may be efficiently generated. This means, therefore, in particular, that the remote control of the lateral guidance and/or of the longitudinal guidance of the motor vehicle may be a function of the respective identification.

Thus, for example, particular drivers, who in the past have paid no fees for the assisted crossing of a junction may be efficiently excluded for an instantaneous assisted crossing. In this way, drivers may, in particular, be identified, who in the past have abused the assisted crossing, so that the corresponding drivers may also be excluded.

According to one specific embodiment of the present invention, it is provided that at least one motor vehicle parameter is received, the remote control signals being generated based on the at least one motor vehicle parameter.

This may yield, for example, the technical advantage that the remote control signals may be efficiently generated. In this way, the remote control signals may, in particular be efficiently generated for the specific motor vehicle. Thus, for example, a maximum possible motor vehicle speed, a maximum possible motor vehicle acceleration, an instantaneous motor vehicle load and/or an instantaneous motor vehicle weight, a length, a width, a height a maximum possible steering angle, a wheelbase, a turning circle radius and/or a turning circle diameter may be efficiently taken into account.

According to one specific embodiment of the present invention, it is provided that lacking a reception of at least one motor vehicle parameter, the remote control signals are generated based on a motor vehicle standard parameter corresponding to the at least one motor vehicle parameter.

This may yield, for example, the technical advantage that it is possible to efficiently react to missing motor vehicle parameters.

According to one specific embodiment of the present invention, it is provided that the at least one motor vehicle parameter is in each case an element selected from the following group of motor vehicle parameters: maximum possible motor vehicle speed, maximum possible motor vehicle acceleration, instantaneous motor vehicle load, instantaneous motor vehicle weight, length, width and height, maximum possible steering angle, wheelbase, turning circle radius, turning circle diameter.

This may yield, for example, the technical advantage that particularly suitable motor vehicle parameters may be used.

According to one specific embodiment of the present invention, the junction is an intersection or a T-junction.

This may yield, for example, the technical advantage that the motor vehicle is able to efficiently cross the intersection or

T-junction.

According to one specific embodiment of the present invention, it is provided that the crossing includes a left turn or a right turn.

This may yield, in particular, the technical advantage that the motor vehicle is able to efficiently turn left or efficiently turn right.

According to one further specific embodiment of the present invention, it is provided that driving maneuver signals are received, which represent an instantaneous and/or a planned driving maneuver by at least one road user, in particular, a further motor vehicle, in the surroundings of the motor vehicle, the remote control signals being generated based on the driving maneuver signals.

This may yield, for example, the technical advantage that the remote control signals may be efficiently generated. This yields, in particular, the technical advantage that it is possible to efficiently react to driving maneuvers, i.e., in particular to an instantaneous and/or to a planned driving maneuver by at least one road user in the surroundings of the motor vehicle.

According to one specific embodiment of the present invention, it is provided that a road user is one of the following road users: a further motor vehicle, a bicyclist, a truck, a motorcycle or a pedestrian.

According to one specific embodiment of the present invention, it is provided that one or multiple method steps except for the steps of generating and outputting the remote control signals are carried out on board the motor vehicle and/or one or multiple method steps being carried out off board the motor vehicle, in particular, in an infrastructure, preferably in a cloud infrastructure.

This may yield, for example, the technical advantage that the corresponding method steps may be efficiently redundantly carried out. This may, in particular, advantageously further increase a safety.

According to one specific embodiment of the present invention, it is provided that one or multiple method steps are documented, in particular, documented in a block chain.

This may yield, for example, the technical advantage that even after carrying out or executing the method, the block chain may be subsequently analyzed based on the documentation. Documenting in a block chain yields, in particular, the technical advantage that the documentation is tamper-proof and forgery-proof.

A block chain is, in particular, a continually expandable list of data sets, called “blocks,” which are linked to one another with the aid of one or of multiple cryptographic methods. Each block in this case contains, in particular, a cryptographically secure hash (variance coefficient) of the preceding block, in particular, a time stamp and, in particular, transaction dates.

In one specific embodiment of the present invention, it is provided that control signals for controlling a traffic guidance system are generated and output based on the signals from the surroundings and based on the remote control signals, in order to guide traffic in the surroundings of the motor vehicle with the aid of the traffic guidance system, in order to aid the motor vehicle in crossing the junction.

This may yield, for example, the technical advantage that the assisted crossing may be efficiently aided.

A traffic guidance system refers, in particular, to a system for directing road traffic, in particular, with the aid of static traffic signs and/or variable traffic signs. A traffic guidance system includes, in particular, at least one variable traffic sign and/or at least one light signaling system.

A variable traffic sign refers to a traffic sign which, when needed, may be shown, changed or cleared. Thus, it involves a dynamic traffic sign. For example, a variable traffic sign may include an electronic sign or a display unit.

Thus, a traffic guidance system includes one or multiple variable traffic signs and/or one or multiple light signaling systems.

According to one specific embodiment of the present invention, is provided that it is checked whether the totality made up of motor vehicle and infrastructure involved in the method according to the first aspect, including a communication between infrastructure and motor vehicle, is instantaneously secure for the concept “intervention in the motor vehicle for critical actions” described herein. Thus, this means, in particular, that the motor vehicle and/or a local and/or a global infrastructure and/or a communication is/are checked accordingly. The remote control signals are generated based, in particular, on a result of the check.

Thus, this means, in particular, that the components that are used when carrying out the method according to the first aspect are checked for safety, i.e., whether these meet particular safety conditions before the intervention into the driving operation is carried out, i.e., the motor vehicle is remotely controlled.

Important and related criteria are, for example, one or multiple of the previously described safety conditions.

According to one specific embodiment of the present invention, it is provided that the method according to the first aspect is a computer-implemented method.

According to one specific embodiment of the present invention, it is provided that the method according to the first aspect is executed or carried out with the aid of the device according to the second aspect.

Device features result analogously from corresponding method features and vice versa. Thus, this means, in particular, that technical functions of the device according to the second aspect result analogously from corresponding technical functionalities of the method according to the first aspect and vice versa.

The wording “at least one” stands for, in particular, “one or multiple.”

The German abbreviation “bzw.” stands for “or,” which stands for, in particular, “respectively.”

The wording “respective” stands for, in particular, “and/or.”

### BRIEF DESCRIPTION OF THE DRAWINGS

FIG. 1 shows a flowchart of a method for that at least assisted crossing of a junction by a motor vehicle, in accordance with an example embodiment of the present invention.

FIG. 2 shows a device, in accordance with an example embodiment of the present invention.

FIG. 3 shows a machine-readable memory, in accordance with an example embodiment of the present invention.

FIG. 4 shows a junction.

### DETAILED DESCRIPTION OF EXAMPLE EMBODIMENTS

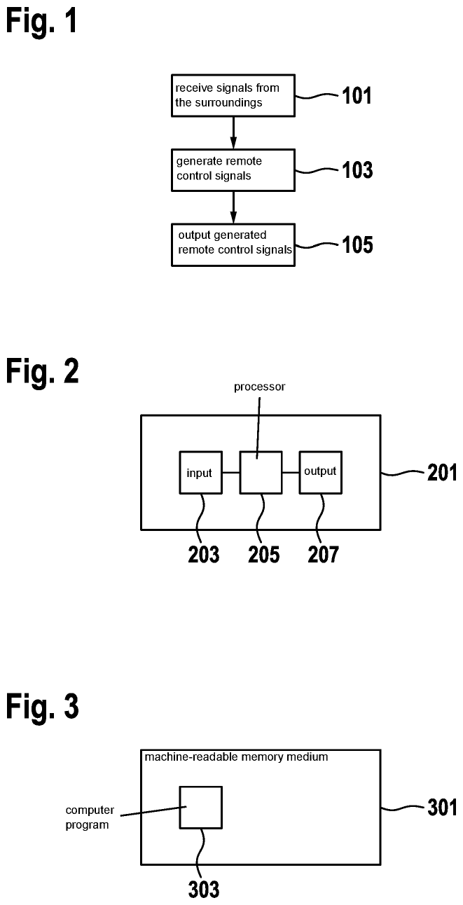

FIG. 1 shows a flowchart of a method for the at least assisted crossing of a junction by a motor vehicle, in accordance with an example embodiment of the present invention.

The method includes the following steps:

receiving 101 signals from the surroundings, which represent surroundings of the motor vehicle that at least partially include a junction, generating 103 remote control signals for remotely controlling a lateral guidance and/or a longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner,

outputting 105 the generated remote control signals.

According to one specific embodiment, it is provided that safety condition signals are received, which represent at least one safety condition that must be met so that the motor vehicle may be remotely controlled, it being checked whether the at least one safety condition is met, the remote control signals being generated based on a result of the check whether the at least one safety condition is met.

The result of the check whether the at least one safety condition is met indicates, for example, that the at least one safety condition is met.

The result of the check whether the at least one safety condition is met indicates, for example, that the at least one safety condition is not met.

According to one specific embodiment, it is provided that the remote control signals are generated and output only when the result of the check whether the at least one safety condition is met indicates that the at least one safety condition is met.

According to one specific embodiment, it is provided that a generation and output of remote control signals is dispensed with if the result of the check whether the at least one safety condition is met indicates that the at least one safety condition is not met.

According to one specific embodiment, the method according to the first aspect includes a remote controlling of the lateral guidance and/or longitudinal guidance of the motor vehicle based on the output remote control signals.

FIG. 2 shows a device 201.

Device 201 is configured to carry out all steps of the method according to the first aspect.

Device 201 includes an input 203, which is configured to receive the signals from the surroundings.

Device 201 includes a processor 205, which is configured to generate the remote control signals based on the signals from the surroundings.

Device 201 further includes an output 207, which is configured to output the generated remote control signals.

For example, the outputting of the generated remote control signals according to one specific embodiment includes sending the remote control signals via a communication network, in particular, via a wireless communication network, to the motor vehicle.

In general, signals that are received, are received with the aid of input 203. Input 203 is thus configured, in particular, to receive the corresponding signals.

In general, signals that are output, are output with the aid of output 207. Output 207 is thus configured, in particular, to output the corresponding signals.

According to one specific embodiment, instead of the one processor 205, multiple processors are provided.

According to one specific embodiment, it is provided that processor 205 is configured to carry out the steps of generating and/or of checking and/or of determining, described previously and/or below.

Device 201 is, for example, part of an infrastructure, in particular, a cloud infrastructure.

FIG. 3 shows a machine-readable memory medium 301.

A computer program 303, which includes commands which, upon execution of computer program 303 by a computer, prompt the computer to carry out a method according to the first aspect, is stored on machine-readable memory medium 301.

According to one specific embodiment, device 201 includes a remote control unit, which is configured to remotely control the motor vehicle based on the generated remote control signals.

According to one specific embodiment, an infrastructure or an infrastructure system is provided, which includes, for example, the device according to the second aspect.

The infrastructure includes, for example, a junction.

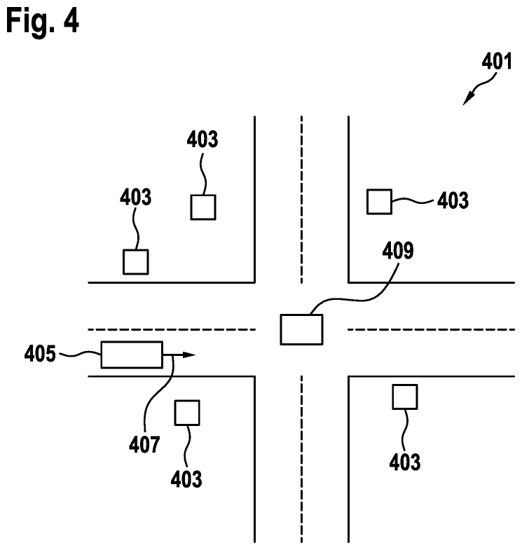

FIG. 4 shows an intersection 401 as an example of a junction.

Multiple surroundings sensors 403 are situated spatially distributed in the intersection area, which detect their respective surroundings.

Respective surroundings sensors 403 provide surroundings sensor data corresponding to the respective detection. For example, surroundings sensors 403 transmit their surroundings sensor data as signals from the surroundings to the device according to the second aspect. This means, therefore, that according to one specific embodiment, the device according to the second aspect receives surroundings sensor data as signals from the surroundings.

The surroundings sensor data are processed, for example, in order to detect a motor vehicle that is approaching intersection 401.

Such a motor vehicle is shown in FIG. 4 with reference numeral 405. An arrow with reference numeral 407 marks a driving direction of the motor vehicle, which extends from left to right with respect to the paper plane.

For example, it is provided according to one specific embodiment that upon detection of a motor vehicle approaching intersection 401, it is determined that a motor vehicle is to cross intersection 401.

For example, it is then provided that a communication link between a device according to the second aspect (not shown) and motor vehicle 405 is established.

Via this communication link, it is then possible to transmit the remote control signals generated by the device to motor vehicle 405 for remote controlling a lateral guidance and/or longitudinal guidance of motor vehicle 405, as described above and/or below.

For example, it is provided according to one specific embodiment that motor vehicle 405 sends a request to the device according to the second aspect that it wishes to be assisted when crossing intersection 401.

In response to a receipt of such a request, it is then determined according to one specific embodiment that a motor vehicle is to cross intersection 401.

The remote control signals are then transmitted accordingly to motor vehicle 405 via the communication link.

According to one specific embodiment, a permanent communication link exists between motor vehicle 405 and the device.

A light signaling system 409 is provided essentially centrally above intersection 401, which directs or regulates traffic that intends to cross intersection 401.

According to one specific embodiment, it is provided that control signals for controlling light signaling system 409 are generated and output, these control signals being of the type that when controlling light signaling system 409 based on the control signals, light signaling system 409 signals motor vehicle 405 visually using a green signal that it has free passage and light signaling system 409 signals cross traffic visually using a red signal that the cross traffic must stop.

Thus, by using a light signaling system, the assisted crossing of an intersection by a motor vehicle may be efficiently aided.

According to one specific embodiment, it is checked whether an instantaneous traffic situation allows an intervention, i.e., in particular, a remote control in order, for example, to prevent other road users in the surroundings of the motor vehicle from being injured.

According to one specific embodiment, it is provided that the process, i.e., the method, in other words, the method steps, are documented in a forgery-proof and comprehensible manner, for example, documented in a block chain.

According to one specific embodiment, it is provided that a driver of the motor vehicle is informed that an intervention in the driving operation of the motor vehicle has taken place or is taking place, i.e., that the motor vehicle has been remotely controlled or is being remotely controlled.

Thus, this means, in particular, that communication signals are generated and output, which represent a corresponding communication. For example, the communication signals are output to a human-machine interface of the motor vehicle, so that the driver is informed of the intervention or of the remote control based on the communication signals with the aid of the human-machine interface.

According to one specific embodiment, a requirement for the remote control or for the intervention is that the remote control is safe. The German word “Sicker” means within the context of the description, in particular, “safe” and “secure.”

These two English terms are normally translated into German as “sicker.” Nevertheless, these terms in English have partially different meanings.

The English term “safe” is directed, in particular, to the issue of accidents and accident avoidance. A remote control that is “safe” ensures that a probability of an accident or of a collision is less than or less than-equal to a predetermined probability threshold value.

The term “secure” is directed, in particular, to the issue of computer protection or hacker protection, i.e., in particular, how securely is a (computer) infrastructure and/or a communication infrastructure, in particular, a communication path between a motor vehicle and a remote control unit for remotely controlling a motor vehicle safeguarded from unauthorized accesses or from data manipulation by third parties (“hackers”).

Thus, a remote control that is “secure” has, in particular, as a basis an appropriate and sufficient computer protection or hacker protection.

According to one specific embodiment, for example, it is checked whether the totality made up of motor vehicle and infrastructure involved in the method according to the first aspect, including a communication between infrastructure and motor vehicle, is instantaneously secure for the concept “intervention in the motor vehicle for critical actions” described herein. Thus, this means, in particular, that the motor vehicle and/or a local and/or a global infrastructure and/or a communication is/are checked accordingly. The remote control signals are generated based, in particular, on a result of the check.

Thus, this means, in particular, that the components that are used when carrying out the method according to the first aspect are checked for safety, i.e., whether these meet particular safety conditions before the intervention into the driving operation is carried out, i.e., the motor vehicle is remotely controlled.

Important and related criteria are, for example, one or multiple of the previously described safety conditions.

According to one specific embodiment, it is provided that on the one hand the entire system (motor vehicle, infrastructure, communication path, cloud, etc.) is checked with respect to the safety condition.

According to one specific embodiment, it is provided that the individual parts are also checked with respect to meeting the safety condition. This, in particular, before remotely controlling the motor vehicle.

The step or steps of checking in this case are carried out in one specific embodiment on board the motor vehicle and/or off board the motor vehicle, in particular, in an infrastructure.

According to one specific embodiment, it is provided that the step or steps of checking is or are checked subsequently, i.e., at a later point in time, for example, regularly. For example, the step or steps of checking is or are checked subsequently at a predetermined frequency, for example, every 100 ms.

For example, this check, i.e., the check whether the at least one safety condition is met, according to one specific embodiment takes place before and/or after and/or during one or multiple predetermined method steps.

According to one specific embodiment, the check is carried out or executed in the case of problems.

In one specific embodiment, notification signals are received, which represent a notification for an at least assisted crossing of a junction with the aid of a motor vehicle.

In one specific embodiment, request signals are received, which represent a request for an at least assisted crossing of a junction with the aid of a motor vehicle.

The request signals and/or notification signals are, for example, sent by the motor vehicle via a wireless communication network.

The request and/or the notification relate according to one specific embodiment to a specific junction.

The request and/or the notification relate according to one specific embodiment to junctions in general.

This means, for example, that the motor vehicle emits request signals or notification signals constantly, i.e. continuously, in particular, repeatedly at a predefined frequency via a wireless communication network.

The remote control signals according to one specific embodiment are generated automatically when the motor vehicle, for example, approaches the specific junction or a junction, and is therefore situated at a predefined distance to the junction.

In one specific embodiment, an establishment of a communication link between motor vehicle and infrastructure is provided, which includes, in particular, the device according to the second aspect.

The infrastructure according to one specific embodiment includes a local infrastructure, for example, a junction.

The infrastructure according to one specific embodiment includes a global infrastructure, for example, a cloud infrastructure.

In one specific embodiment, it is checked whether the functionality “assisted crossing of a junction” may be provided.

In one specific embodiment, it is checked whether the infrastructure is functionally ready and/or is available for the assisted crossing of a junction.

In one specific embodiment, it is checked whether the motor vehicle is functionally ready and/or is available for the assisted crossing of a junction.

In one specific embodiment, it is checked whether the service or the functionality “assisted crossing of a junction” is made available for the motor vehicle (or driver or owner) requesting the functionality. This both, in particular, at the motor vehicle level, at the infrastructure level, at the service level. For example, it is provided that a provider of the functionality “assisted crossing of a junction” no longer allows the requesting motor vehicle or its owner and its driver due to fees not paid in the past or due to abuses.

In one specific embodiment, an ascertainment and/or a reception (and, in particular, a transfer) of motor vehicle possibilities (the motor vehicle parameters described previously and below) (for example, maximum possible acceleration and/or speed, etc.) is/are provided. For example, motor vehicle parameters are sent by the motor vehicle. Thus, this means that, for example, motor vehicle parameters sent by the motor vehicle are received.

For example, motor vehicle parameters are sent from the cloud, in particular, by a cloud server. Thus, this means that, for example, motor vehicle parameters sent by the cloud, in particular, by a cloud server are received.

If this is not possible (for example, due to missing data), a defined standard configuration (preferably an emergency configuration) is then used.

In one specific embodiment, it is provided that data signals are received, which represent respective data of the motor vehicle or from at least one further road user, in particular, a further motor vehicle. The data include, for example, pieces of traffic surroundings information or traffic surroundings functions. The data are used, for example, in order to support or to improve an evaluation or processing of the surroundings sensor data of surroundings sensor 403. Thus, this means, in particular, that an evaluation or processing is carried out on the basis of the data. The data are sent, for example, by the motor vehicle or by the at least one further road user via a, in particular wireless, communication network.

In one specific embodiment, a check is provided whether the traffic situation allows for the motor vehicle to be able to cross the junction in an assisted manner. This check runs preferably continuously, i.e. permanently—this means even prior to a corresponding request, i.e., regardless of a request.

Other road users in one further specific embodiment preferably also send—if possible—via V2X their instantaneous and planned driving maneuvers to the motor vehicle and/or to the cloud server.

In one specific embodiment, a calculation or ascertainment is provided whether an at least assisted crossing of the junction by the motor vehicle is possible.

The calculation or ascertainment is/are carried out, for example, in the motor vehicle and/or in the infrastructure. If this is carried out in both the motor vehicle as well as in the infrastructure, a redundancy may be advantageously ensured, which may increase a safety.

If the at least assisted crossing is possible, the motor vehicle is distantly remotely controlled, for example. The guidance of the motor vehicle is thus taken over by the infrastructure. Intelligence, decision and control lie with the infrastructure.

The motor vehicle thus travels, in particular, remotely controlled over the junction, i.e., crosses the latter. The crossing includes, for example, a left turn or a right turn.

The process of crossing in this case preferably continues to be checked.

The check is carried out in this case according to one or to multiple of the following possibilities:

In the motor vehicle, in the infrastructure or in both the motor vehicle as well as in the infrastructure, the latter being able to advantageously ensure a redundancy, which may increase a safety.

The entire process starts preferably very early, so that the motor vehicle does not have to stop before the junction. This means the speed does not have to be reduced, for example, because not all notification processes/analysis processes (checking steps) are completed.

In one specific embodiment, the entire traffic in the surroundings of the motor vehicle is automatically regulated or organized in a coordinated manner by the infrastructure using a traffic guidance system that includes, in particular, traffic system(s), in particular, light signaling system(s), in such a way that an optimal process (optimal at least assisted crossing) is achieved or ensured for the motor vehicle and for further motor vehicles, that are able to be at least semi-automatically driven, in particular, able to be remotely controlled, and/or for further motor vehicles that are not able to be at least semi-automatically driven, in particular, not able to be remotely controlled.

This means that precisely when according to one specific embodiment, in addition to the motor vehicle, the infrastructure also takes control of further motor vehicles that are able to be at least semi-automatically driven, in particular, able to be remotely controlled, the entire traffic is regulated in such a way that an optimal traffic flow is achieved.

According to one specific embodiment, it is provided that the step or steps of checking is or are checked subsequently, i.e., at a later point in time, for example, regularly. For example, the step or steps of checking is or are checked subsequently at a predetermined frequency, for example, every 100 ms.

For example, this check, i.e., the check whether the at least one safety condition is met, according to one specific embodiment takes place before and/or after and/or during one or multiple predetermined method steps.

According to one specific embodiment, the check is carried out or executed in the case of problems.

1-20. (canceled)

21. A method for an at least assisted crossing of a junction by a motor vehicle, comprising the following steps:
receiving signals from surroundings, which represent surroundings of the motor vehicle that at least partially include a junction;
generating remote control signals for remotely controlling a lateral guidance and/or longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner;
outputting the generated remote control signals.

22. The method as recited in claim 21, further comprising:
receiving safety condition signals, which represent at least one safety condition that has to be met, so that the motor vehicle may be remotely controlled; and
checking whether the at least one safety condition is met;
wherein the remote control signals are generated based on a result of the check of whether the at least one safety condition is met.

23. The method as recited in claim 22, wherein the at least one safety condition is in each case an element selected from the following groups of safety conditions:
presence of a predetermined safety integrity level or automotive safety integrity level of at least the motor vehicle and of an infrastructure, including a communication path and/or communication component for remotely controlling a motor vehicle, with respect to systems in the motor vehicle and in the infrastructure;
presence of a maximum latency period of a communication between the motor vehicle and a remote control unit for remotely controlling the motor vehicle based on the remote control signals;
presence of a predetermined computer protection level of a device for carrying out the steps of the method;
presence of predetermined components and/or algorithms and/or communication options, which are used for carrying out the steps of the method;
presence of a redundancy and/or diversity in predetermined components and/or in algorithms and/or in communication options, which are used for carrying out the steps of the method;
presence of predetermined availability indications, which indicate an availability of predetermined components and/or of algorithms and/or of communication options;
presence of predetermined quality criteria of the predetermined components and/or of algorithms and/or of communication options;
presence of a plan that includes measures for reducing errors and/or measures in case of failures of predetermined components and/or of algorithms and/or of communication options and/or measures for error analyses and/or measures in case of misinterpretations;
presence of one or of multiple fall-back scenarios;
presence of a predetermined function, presence of a predetermined traffic situation;
presence of predetermined weather;
maximum possible time for respectively carrying out or executing one or multiple steps of the method;
presence of a check result that elements or functions that are used for carrying out the method are presently function correctly.

24. The method as recited in claim 22, wherein the remote control signals are generated only when the at least one safety condition is met.

25. The method as recited in claim 22, wherein the check of whether the at least one safety condition is met is carried out before and/or after and/or during one or multiple predetermined method steps.

26. The method as recited in claim 21, wherein after outputting the remote control signals, a remote control of the motor vehicle based on the output remote control signals is checked in order to detect an error, (i) the remote control being aborted upon detection of an error, or (ii) emergency remote control signals being generated and output in a case of emergency for remotely controlling the lateral guidance and/or longitudinal guidance of the motor vehicle.

27. The method as recited in claim 21, wherein identification signals are received, which represent a respective identification of at least one of: (i) the motor vehicle, (ii) an owner of the motor vehicle, (iii) a driver of the motor vehicle, the remote control signals being generated based on the respective identification.

28. The method as recited in claim 21, wherein at least one motor vehicle parameter of the motor vehicle is received, the remote control signals being generated based on the at least one motor vehicle parameter.

29. The method as recited in claim 21, wherein lacking a reception of at least one motor vehicle parameter, the remote control signals are generated based on a motor vehicle standard parameter corresponding to the at least one motor vehicle parameter.

30. The method as recited in claim 28, wherein the at least one motor vehicle parameter is in each case an element selected from the following group of motor vehicle parameters: a maximum possible motor vehicle speed, a maximum possible motor vehicle acceleration, an instantaneous motor vehicle load and/or an instantaneous motor vehicle weight, a length, a width, a height, a maximum possible steering angle, a wheelbase, a turning circle radius and/or a turning circle diameter.

31. The method as recited in claim 21, wherein the junction is an intersection or a T-junction.

32. The method as recited in claim 21, wherein the crossing includes a left turn or a right turn.

33. The method as recited in claim 21, wherein driving maneuver signals are received, which represent an instantaneous and/or a planned driving maneuver by at least one road user in the surroundings of the motor vehicle, the remote control signals being generated based on the driving maneuver signals.

34. The method as recited in claim 21, wherein one or multiple method steps of the method except for the steps of generating and outputting the remote control signals are carried out on board the motor vehicle and/or one or multiple of the method steps are carried out off board the motor vehicle in an infrastructure, the infrastructure being a cloud infrastructure.

35. The method as recited in claim 21, wherein one or multiple of the method steps are documented in a block chain.

36. The method as recited in claim 21, wherein control signals for controlling a traffic guidance system are generated and output based on the signals from the surroundings and based on the remote control signals, to guide traffic in the surroundings of the motor vehicle using the traffic guidance system, to aid the motor vehicle in crossing the junction.

37. The method as recited in claim 21, wherein it is checked whether a totality made up of motor vehicle and infrastructure involved in the method including a communication between the infrastructure and the motor vehicle, is secure, so that the motor vehicle and/or a local and/or a global infrastructure and/or a communication between a motor vehicle and an infrastructure is/are checked accordingly.

38. A device configured for an at least assisted crossing of a junction by a motor vehicle, the device configured to:
receive signals from surroundings, which represent surroundings of the motor vehicle that at least partially include a junction;
generate remote control signals for remotely controlling a lateral guidance and/or longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner;
output the generated remote control signals.

39. A non-transitory machine-readable memory medium on which is stored a computer program for the at least assisted crossing of a junction by a motor vehicle, the computer program, when executed by a computer, causing the computer to perform the following steps:
receiving signals from surroundings, which represent surroundings of the motor vehicle that at least partially include a junction;
generating remote control signals for remotely controlling a lateral guidance and/or longitudinal guidance of the motor vehicle based on the signals from the surroundings in such a way that when remotely controlling the lateral guidance and/or longitudinal guidance of the motor vehicle based on the remote control signals, the motor vehicle crosses the junction in an at least assisted manner;
outputting the generated remote control signals.
